(19) United States
(12) Patent Application Publication
(10) Pub. No.: US 2012/0009049 A1
(43) Pub. Date: Jan. 12, 2012

(54) RED HOT COKE RECEIVING AND CONVEYING APPARATUS

(76) Inventor: Takeshi Sekiguchi, Kanagawa (JP)

(21) Appl. No.: 12/736,938

(22) PCT Filed: Jun. 17, 2010
(86) PCT No.: PCT/JP2010/060267

§ 371 Date: Nov. 22, 2010

(51) Int. Cl. C10B 39/14; B65G 67/02

(52) U.S. Cl. 414/399

(57) ABSTRACT

To obtain a red hot coke receiving and conveying apparatus that can increase the volumetric efficiency of a conveying bucket and has a simple configuration. A red hot coke receiving and conveying apparatus 1 according to the present invention includes a red hot coke receiving apparatus 5, on which is placed a conveying bucket 3 that has a discharge gate open/close mechanism 31 on a lower portion, wherein red hot coke receiving apparatus 5 receives red hot coke from a coke oven by the conveying bucket, and a hoisting tower 7 which hoists the conveying bucket 3 to a coke dry quenching facility side. The red hot coke receiving apparatus 5 includes a main carriage 13 which travels along a rail 11 provided along the coke oven, a sub-carriage 17 which moves the conveying bucket between the main carriage 13 and the hoisting tower 7, and a rotary table 15 which is provided on the main carriage 13 for rotating the conveying bucket. The hoisting tower 7 includes a hoisting hook 21 having hooking arms 19 capable of holding a lower portion of the conveying bucket 3 that has moved to the hoisting tower side and a hoisting mechanism 25 for hoisting the hoisting hook 21.

### TECHNICAL FIELD

The present invention relates to a red hot coke receiving and conveying apparatus that receives red hot coke from a coke oven and conveys it to a coke dry quenching facility side.

### BACKGROUND ART

Conventionally, a red hot coke receiving and conveying apparatus including a cylindrical conveying bucket that can be hoisted by a hoisting frame mechanism is used to receive red hot coke discharged from a coke oven, and to carry and charge it into a coke dry quenching facility.

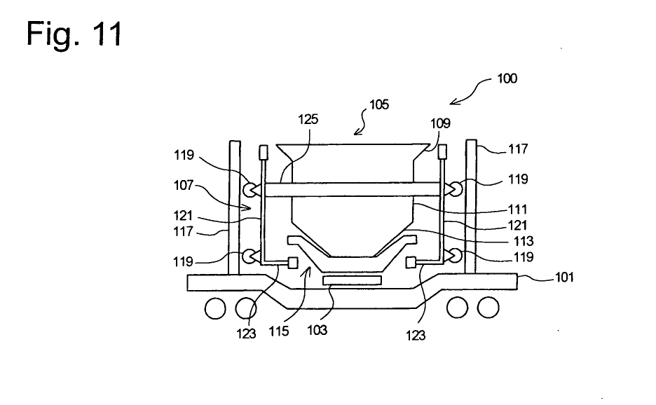

FIG. 11 is an explanatory diagram illustrating a conventional red hot coke receiving apparatus 100 illustrated in Patent Document 1. This conventional red hot coke receiving apparatus 100 includes a carriage 101 that travels along a rail, a rotary table 103 arranged on the carriage 101, a conveying bucket 105 placed on the rotary table 103, and a hoisting frame mechanism 107 that is arranged on the carriage 101 for hoisting the conveying bucket 105.

The conveying bucket 105 includes a flange portion 109 having a gradually increasing diameter that is provided on an upper end of the conveying bucket 105, a cylindrical bucket main portion 111 formed so as to be continuous with the flange portion 109 and extend downward therefrom, and a conical portion 113 having a gradually decreasing diameter that is formed so as to be continuous with and continue downwards from the bucket main portion 111. A discharge gate open/close mechanism 115 for discharging coke is provided on the conical portion 113.

The hoisting frame mechanism 107 includes a carriage-side guide rail 117 erected at the front and back of the carriage 101, and a hoisting hook 121 that has side rollers 119 capable of moving up and down along the carriage-side guide rail 117. The hoisting hook 121 has hooking arms 123. A lower end side of the hooking arms bends inwards (toward the conveying bucket 105 side), so that from side-on the overall shape of each side of the hoisting hook 121 is like the letter L. The hooking arms 123 support the discharge gate, so that the conveying bucket 105 can be held. Further, the hoisting hook 121 includes an outer frame 125, which is arranged so as to enclose the circumference of the conveying bucket 105 in order to ensure rigidity.

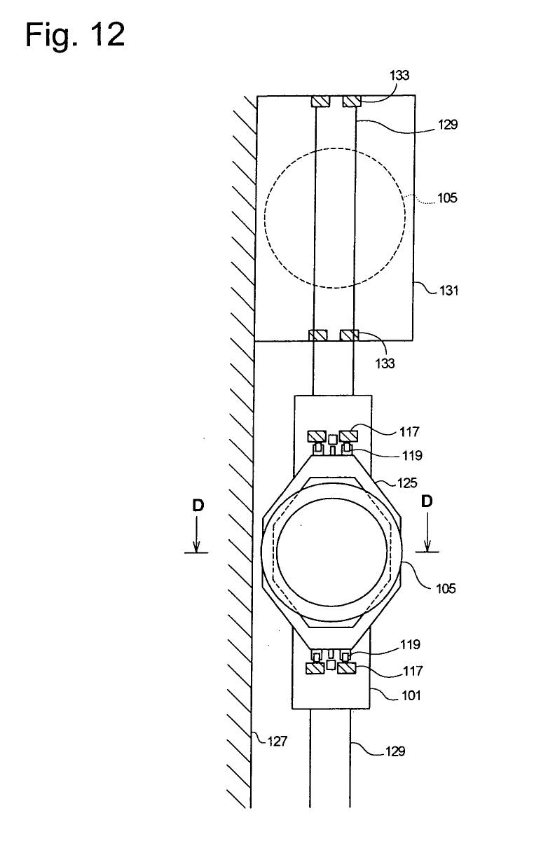

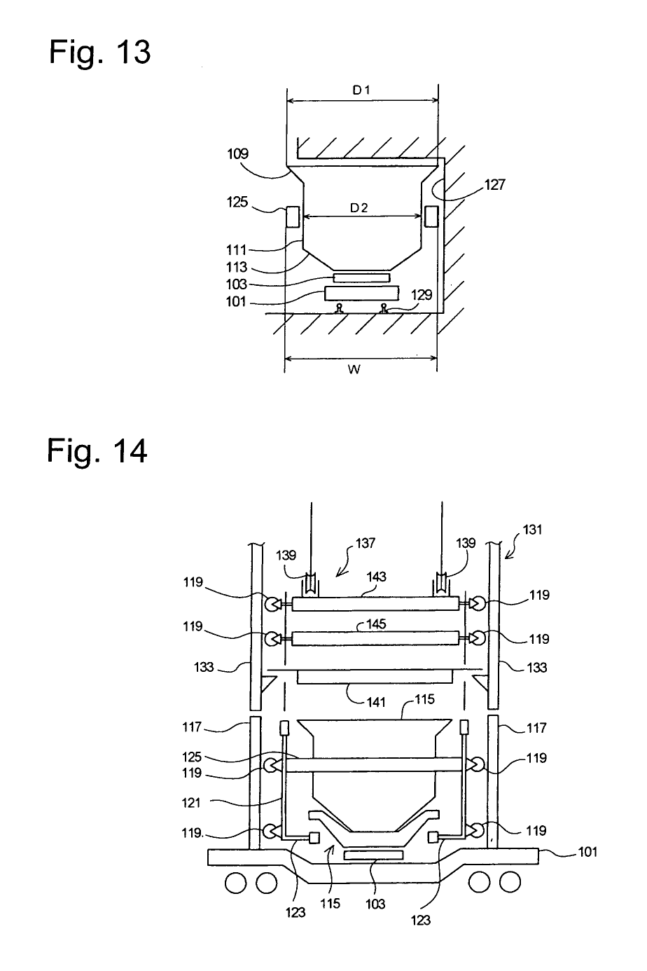

As illustrated in FIGS. 12 and 13, for a conventional coke receiving apparatus configured in the above manner, the carriage 101 travels along a rail 129 provided along a coke oven 127, and the red hot coke is received from the coke oven 127. During reception of the red hot coke, by rotating the rotary table 103, the red hot coke can be uniformly received in the conveying bucket 105, and the coke volumetric efficiency can be increased.

The carriage 101 on which the conveying bucket 105 that received the red hot coke is placed moves to a predetermined position in a hoisting tower 131 in order to convey the red hot coke to a coke dry quenching facility (hereinafter, “CDQ facility”) (refer to FIG. 12). As illustrated in FIG. 14, at the hoisting tower 131, a hoisting hook set 137 includes a guide rail 133 and side rollers 119 capable of moving up and down along the guide rail 133. The hoisting hook set 137 is arranged so that it can move up and down by a moving pulley 139. A bucket cover 141 is provided in the hoisting hook set 137.

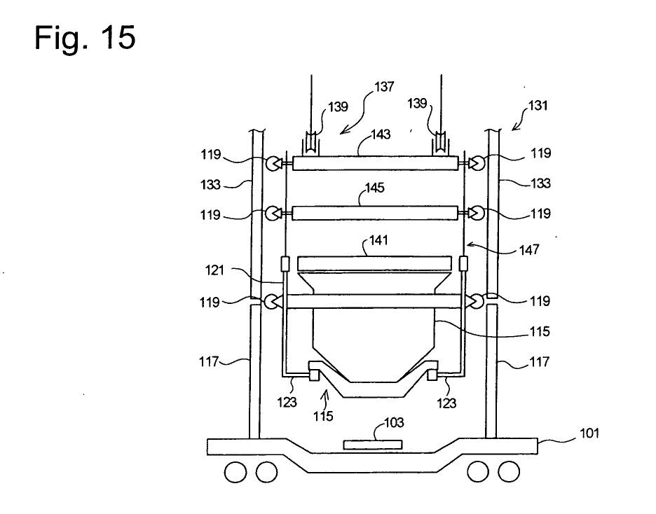

Although simplified in FIGS. 14 and 15, the hoisting hook set 137 has a top hoisting beam 143, a bottom hoisting beam 145, and open/close hooks 147. The open/close hooks 147 are configured so as to be capable of releasably holding an upper end portion of the hoisting hook 121.

The carriage 101, which has moved to a position in the hoisting tower 131, stops at a position where the carriage-side guide rail 117 continues on to the guide rail 133. If the hoisting hook set 137 is hoisted at that position, as illustrated in FIG. 15, the space between the top hoisting beam 143 and the bottom hoisting beam 145 grows larger, so that the hoisting hook 121 is automatically held by the open/close hooks 147. If the hoisting hook set 137 is hoisted further, as illustrated in FIG. 14, the hoisting hook 121 moves upward, so that the hooking arms 123 of the hoisting hook 121 support the discharge gate. Consequently, the conveying bucket is lifted up onto the rotary table 103. After the bucket cover 141 is placed on top of the conveying bucket 105, the conveying bucket 105 is conveyed to the CDQ facility side.

Thus, the conventional red hot coke receiving apparatus 100 separately provides the mechanisms required to hoist the conveying bucket 105 on the hoisting tower 131 side and on the conveying bucket 105 side. Therefore, when receiving red hot coke, the red hot coke is received with the hoisting frame mechanism 107, which is a part of the red hot coke receiving apparatus 100, accompanying the conveying bucket 105. Further, during hoisting, the hoisting frame mechanism 107 is coupled with the hoisting hook set 137 on the hoisting tower 131 side.

Due to such a configuration, the hoisting frame mechanism 107 constantly accompanies the conveying bucket 105. In addition, the outer frame 125 is required to ensure the rigidity of the hoisting frame mechanism 107, and especially, that of the hoisting hook 121.

Since the outer frame 125 protrudes outward from the conveying bucket 105, the conveying bucket 105 has to be separated from the coke oven. Consequently, a gap is formed between the conveying bucket 105 and the coke oven. Therefore, received red hot coke can drip down from this gap. To prevent this, the flange portion 109 is provided on the upper end of the conveying bucket 105.

Thus, due to the fact that the conveying bucket 105 requires the flange portion 109 because of the presence of the outer frame 125, there is the following problem.

As illustrated in FIG. 13, if the outer diameter of the upper end of the conveying bucket 105 is D1, the outer diameter of the bucket main portion 111 is D2, and the outer diameter of the outer frame 125 is W, D1≧W>D2. Further, since D1−D2 is about 1,000 mm, and D1=5,000 mm to 7,000 mm, if D1=6,000 mm for example, (D2/D1)=(5,000/6,000), which is roughly equal to about 70%. More specifically, due to the presence of the outer frame 125, the conveying bucket 105 volume is reduced by 30%.

To resolve this problem, Patent Document 2 realizes an apparatus that can rotate even in a confined location such as a small coke oven, by arranging the outer frame 125 on the conical portion 113 of the conveying bucket 105 to prevent the outer frame 125 from protruding out from the bucket main portion 111 of the conveying bucket 105, thereby improving the volumetric efficiency.
[Patent Document 1] Japanese Examined Patent Application Publication No. 63-14032
[Patent Document 2] WO/2007/1055131A1

### DISCLOSURE OF THE INVENTION

### Problems to be Solved by the Invention

However, this does not change the fact that in the apparatus described in Patent Document 2, similar to Patent Document 1, the hoisting frame mechanism 107 constantly accompanies the conveying bucket 105. Patent Document 2 merely configures the apparatus so that the outer frame 125, which is a member forming the hoisting frame mechanism 107, does not protrude.

Moreover, since the hoisting frame mechanism 107 accompanies the conveying bucket 105 even when receiving red hot coke, the following problems still remain.

In Patent Document 2, although the outer frame 125 is arranged on the conical portion 113 of the conveying bucket 105, the discharge gate open/close mechanism 115 is provided on the conical portion 113. Consequently, it is difficult to arrange the outer frame 125 so that it does not inhibit the rotation of the conveying bucket 105, and so that it does not protrude. In practice, a part of the outer frame 125 has to protrude. Thus, currently there is still a gap between the coke oven and the conveying bucket 105 due to the presence of the outer frame 125.

Consequently, the flange portion 109 needs to be provided on the conveying bucket 105 to prevent dripping of coke that has splashed into this gap during reception of red hot coke. If the flange portion 109 is necessary, the volumetric efficiency deteriorates by that amount. In addition, since the hoisting frame mechanism 107, which should not be necessary during reception of red hot coke, is provided, the hoisting frame mechanism 107 can become a hindrance in a small coke oven.

Further, during hoisting, since the hoisting hook set 137 and the hoisting frame mechanism 107 need to be coupled, a complex coupling mechanism for that purpose becomes necessary. As the coupling mechanism, in addition to a coupling mechanism for coupling the hoisting hook 121 and the hoisting hook set 137, a mechanism that is coupled with or centers the guide rail 133 is also necessary.

Thus, the conventional red hot coke receiving apparatus 100 still has problems that need to be resolved.

The present invention is directed to resolving the above-described problems. It is an object of the present invention to obtain a red hot coke receiving and conveying apparatus that can increase the volumetric efficiency of a conveying bucket and has a simple configuration.

### Means for Solving the Problems

The conventional red hot coke receiving apparatus has a structure in which the hoisting frame mechanism 107, which is a mechanism required during hoisting, accompanies the conveying bucket. The reason why the hoisting frame mechanism 107 is thus accompanying the conveying bucket is thought to be as follows. Specifically, the hoisting hook 121 has hooking arms 123 that are bent inward. Since these hooking arms 123 support a lower portion of the conveying bucket, to achieve an arrangement relationship in which the hooking arms 123 can fit under the conveying bucket, it was believed that such an arrangement had to be pre-built.

However, the present inventor considered that the hoisting frame mechanism 107 said to be required for hoisting is unnecessary when receiving the red hot coke. Thus, the present inventor conceived the idea of separating the devices required for the conveying bucket and hoisting, and arranging the devices required during hoisting on the hoisting tower side, thereby completely the present invention. More specifically, the present invention comprises the following.
(1) A red hot coke receiving and conveying apparatus according to the present invention includes a red hot coke receiving apparatus on which is placed a conveying bucket having a discharge gate open/close mechanism on a lower portion, wherein the red hot coke receiving apparatus receives red hot coke from a coke oven by the conveying bucket, and a hoisting tower which hoists the conveying bucket to a coke dry quenching facility side, characterized in that the red hot coke receiving apparatus includes a main carriage which travels along a rail provided along the coke oven, a conveying bucket moving apparatus which moves the conveying bucket between the main carriage and the hoisting tower, and a rotary mechanism which is provided on the conveying bucket moving apparatus or the main carriage for rotating the conveying bucket, and the hoisting tower includes a hoisting hook having hooking arms capable of holding a lower portion of the conveying bucket that has moved to the hoisting tower side and a hoisting mechanism for hoisting the hoisting hook.
(2) Further, in the red hot coke receiving and conveying apparatus according to the above (1), the conveying bucket includes a cylindrical bucket main portion and a lower conical portion having a decreasing diameter, and that the conveying bucket does not have on an upper end portion a flange portion having an increasing diameter.
(3) In addition, in the red hot coke receiving and conveying apparatus according to the above (1) or (2), the hoisting hook is formed in a portal shape and has a hooking arm on a lower portion of a hoisting column.
(4) Further, in the red hot coke receiving and conveying apparatus according to any one of the above (1) to (3), a bucket cover which covers an upper end aperture portion of the conveying bucket is provided on the hoisting hook, wherein the conveying bucket can be prevented from tipping over by the bucket cover.
(5) In addition, in the red hot coke receiving and conveying apparatus according to any one of the above (1) to (4), the hoisting tower includes a guide rail for letting the hoisting hook move up and down, wherein the guide rail is continuous from a minor carriage position.

### Advantages of the Invention

The red hot coke receiving and conveying apparatus according to the present invention arranges the devices that are required during hoisting of the hoisting hook and the like, but not required when receiving red hot coke, on the hoisting tower side. Therefore, accompanying devices that are not necessary when receiving red hot coke are not provided around the conveying bucket, and thus the volume of the conveying bucket itself can be increased.

Further, since the devices required for the hoisting of the conveying bucket are concentrated on the hoisting tower side, there is no need to separate the guide rails as in the conventional example. Moreover, a hoisting hook set having a complex configuration also becomes unnecessary, allowing the apparatus to have a very simple configuration.

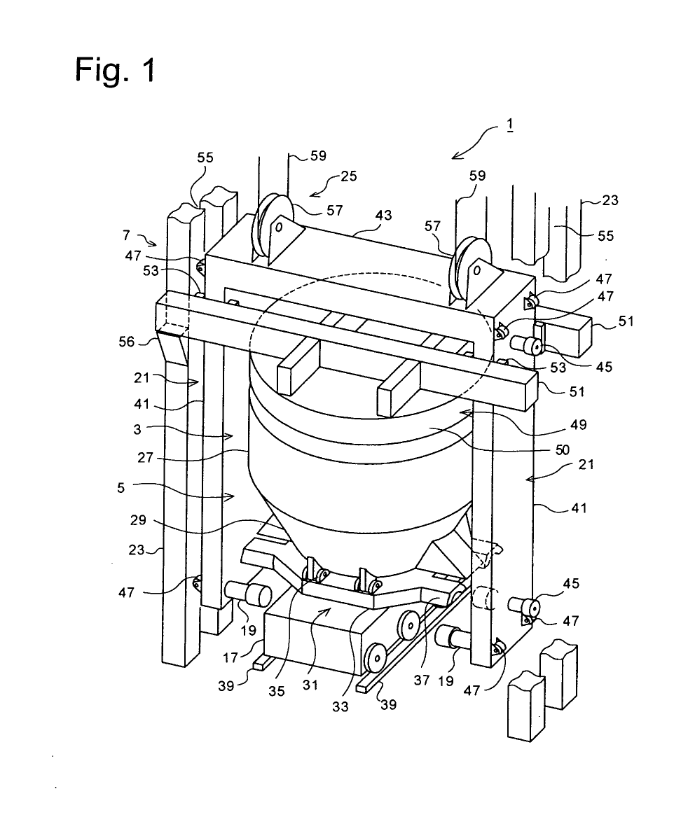

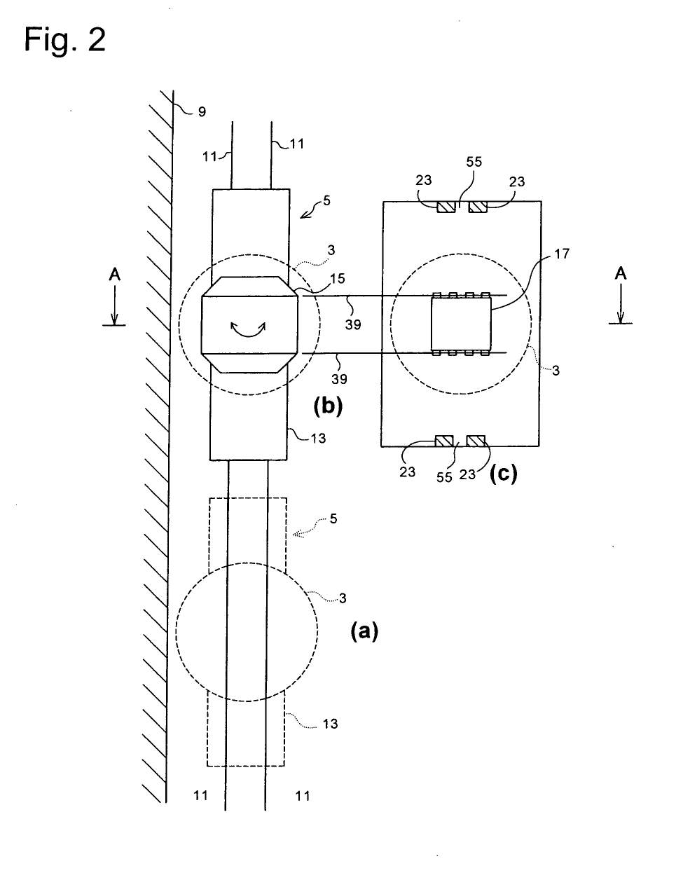

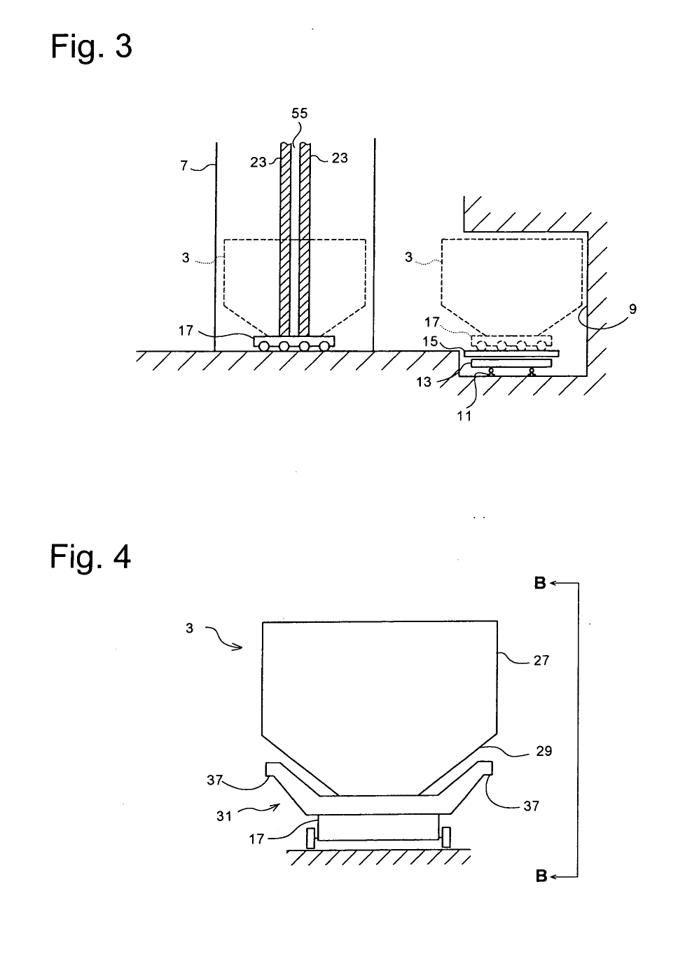

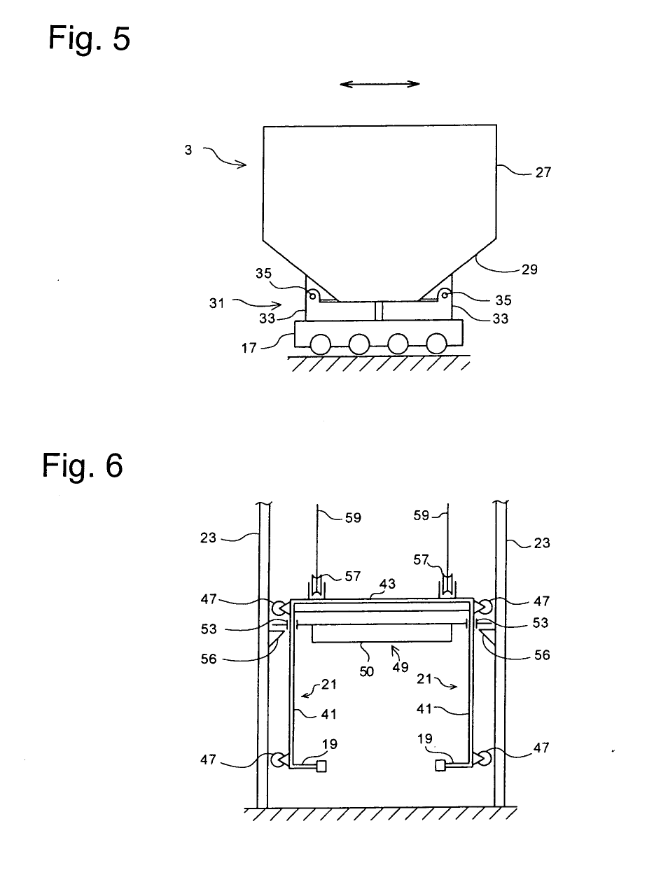

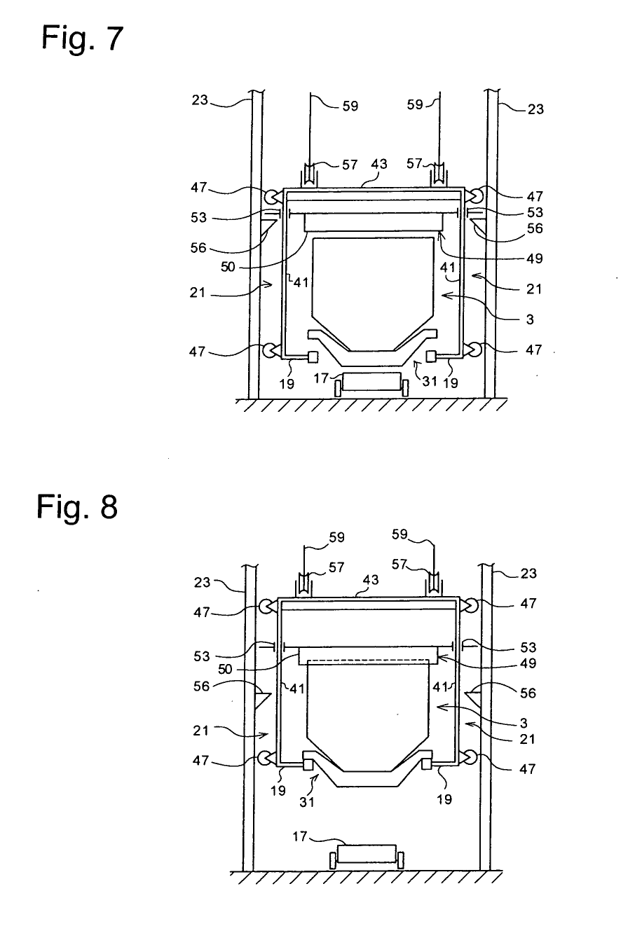

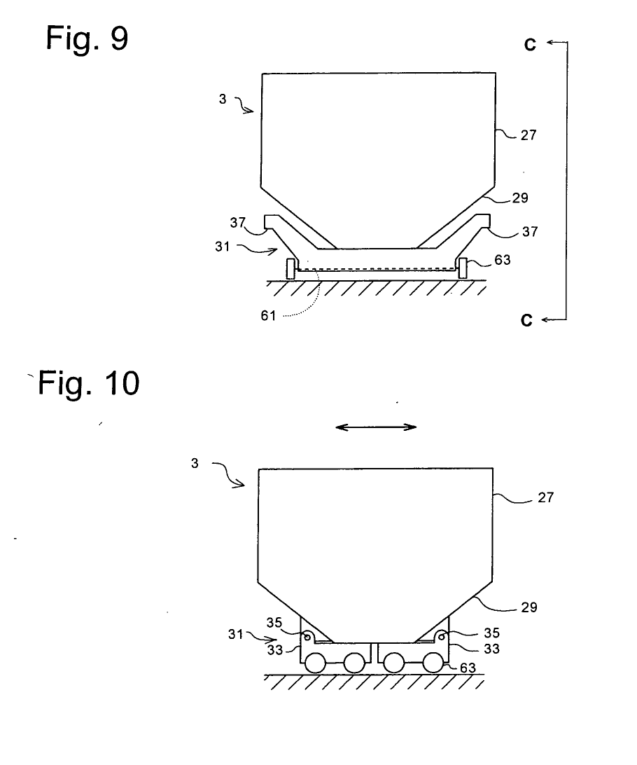

### BRIEF DESCRIPTION OF THE DRAWINGS

[FIG. 1] FIG. 1 is an explanatory diagram illustrating the configuration of a red hot coke receiving and conveying apparatus according to an embodiment of the present invention;

[FIG. 2] FIG. 2 is an explanatory diagram illustrating the configuration and operation of a red hot coke receiving and conveying apparatus according to an embodiment of the present invention;

[FIG. 3] FIG. 3 is a cross-sectional view along the line of arrows A-A in FIG. 2;

[FIG. 4] FIG. 4 is an explanatory diagram illustrating a part of the configuration of a red hot coke receiving and conveying apparatus according to an embodiment of the present invention;

[FIG. 5] FIG. 5 is a view along the line of arrows B-B in FIG. 4;

[FIG. 6] FIG. 6 is an explanatory diagram illustrating a part of the configuration of a red hot coke receiving and conveying apparatus according to an embodiment of the present invention;

[FIG. 7] FIG. 7 is an explanatory diagram illustrating the configuration and operation of a red hot coke receiving and conveying apparatus according to an embodiment of the present invention;

[FIG. 8] FIG. 8 is an explanatory diagram illustrating the configuration and operation of a red hot coke receiving and conveying apparatus according to an embodiment of the present invention;

[FIG. 9] FIG. 9 is an explanatory diagram illustrating another mode of a part of the configuration of a red hot coke receiving and conveying apparatus according to an embodiment of the present invention;

[FIG. 10] FIG. 10 is a view along the line of arrows C-C in FIG. 9;

[FIG. 11] FIG. 11 is an explanatory diagram illustrating the configuration of a conventional red hot coke receiving apparatus;

[FIG. 12] FIG. 12 is an explanatory diagram illustrating the configuration and operation of a conventional red hot coke receiving apparatus;

[FIG. 13] FIG. 13 is a cross-sectional view along the line of arrows D-D in FIG. 12;

[FIG. 14] FIG. 14 is an explanatory diagram illustrating the configuration and operation of a conventional red hot coke receiving apparatus; and

[FIG. 15] FIG. 15 is an explanatory diagram illustrating the configuration and operation of a conventional red hot coke receiving apparatus.

### DESCRIPTION OF THE REFERENCE NUMERALS

1 Red hot coke receiving and conveying apparatus
3 Conveying bucket
5 Red hot coke receiving apparatus
7 Hoisting tower
9 Coke oven
11 Rail
13 Main carriage
15 Rotary table
17 Sub-carriage
19 Hooking arm
21 Hoisting hook
23 Guide rail
25 Hoisting mechanism
27 Bucket main portion
29 Conical portion
31 Discharge gate open/close mechanism
33 Gate
35 Hinge
37 Support portion
39 Traverse rail
41 Hoisting column
43 Hoisting beam
45 First side roller
47 Second side roller
49 Bucket cover
51 Support member
53 Slide guide
55 Guide groove
56 Landing seat
57 Moving pulley
59 Wire
61 Axle
63 Wheel
100 Red hot coke receiving apparatus
101 Carriage
103 Rotary table
105 Conveying bucket
107 Hoisting frame mechanism
109 Flange portion
111 Bucket main portion
113 Conical portion
115 Discharge gate open/close mechanism
117 Carriage-side guide rail
119 Side roller
121 Hoisting hook
123 Hooking arm
125 Outer frame
127 Coke oven
129 Rail
131 Hoisting tower
133 Guide rail
137 Hoisting hook set
139 Moving pulley
141 Bucket cover
143 Top hoisting beam
145 Bottom hoisting beam
147 Open/close hook

### BEST MODE FOR CARRYING OUT THE INVENTION

A red hot coke receiving and conveying apparatus according to an embodiment of the present invention will now be described with reference to the drawings.

The red hot coke receiving and conveying apparatus 1 according to the present invention has a red hot coke receiving apparatus 5 which receives red hot coke by a conveying bucket 3, and a hoisting tower 7 which hoists the conveying bucket 3 to a coke dry quenching facility (CDQ facility) side. The red hot coke receiving apparatus 5 includes a main carriage 13 which travels along a rail 11 provided along a coke oven 9, a rotary table 15 provided on the main carriage 13, and a sub-carriage 17 which moves back and forth between the rotary table 15 on which the conveying bucket 3 is placed and the hoisting tower 7.

Further, the hoisting tower 7 includes a hoisting hook 21 which has hooking arms 19 that can support a lower portion of the conveying bucket 3 placed on the sub-carriage 17, a guide rail 23 which guides the hoisting hook 21, and a hoisting mechanism 25 for hoisting the hoisting hook 21.

Each of these parts will now be described in more detail.

### [Red Hot Coke Receiving Apparatus]

The red hot coke receiving apparatus 5 includes the conveying bucket 3, the main carriage 13, the rotary table 15, and the sub-carriage 17.

### <Conveying Bucket>

The conveying bucket 3 is placed on the sub-carriage 17 in the manner illustrated in FIGS. 1, 4, and 5. The conveying bucket 3 includes a conical portion 29 having a gradually decreasing diameter which is continuous in a downward direction from a bucket main portion 27. A discharge gate open/close mechanism 31 for discharging coke is provided on a lower end of the conical portion 29.

Unlike the conventional example, the conveying bucket 3 according to the present embodiment is not provided with a flange portion on its upper end. The reason for this is as follows.

The conveying bucket 3 according to the present embodiment is placed on the main carriage 13 and moved alongside the coke oven 9 to receive red hot coke from a predetermined coke oven 9. As illustrated in FIG. 3, when the conveying bucket 3 is receiving red hot coke, only the conveying bucket 3 is placed along with the sub-carriage 17 on the rotary table 15 provided on the main carriage 13. Unlike the conventional example, which during hoisting requires an accompanying outer frame 125, hoisting hook 121, carriage-side guide rail 117 and the like, there are no unnecessary accompanying devices during reception of the red hot coke.

Therefore, when the hoisting hook 121 and the outer frame 125, which is provided to ensure the rigidity of the hoisting hook 121, accompany the conveying bucket 3, to prevent coke from splashing toward the accompanying device side during reception of the red hot coke, it was necessary to provide the flange portion 109 (refer to FIG. 11) that extends further outward in a planar view than the accompanying devices. However, since the present embodiment does not have accompanying devices like those in the conventional example, it is not necessary to provide the flange portion 109.

By not providing the flange portion 109, the diameter of the bucket main portion 27 can be made larger than when the flange portion 109 is provided, which allows the volume of the bucket main portion 27 to be increased. Stated from the opposite perspective, for the same volume, the bucket main portion 27 can be made more compact, so that the conveying bucket 3 can also be used in a narrower, smaller coke oven.

The discharge gate open/close mechanism 31 for discharging coke is provided on a lower end portion of the conical portion 29 of the conveying bucket 3. As illustrated in FIGS. 1, 4, and 5, the discharge gate open/close mechanism 31 is configured from two gates 33 arranged so as to cover the lower end of the conveying bucket 3. Each of the gates 33 can swing downwards by a hinge 35 so that a center portion of the discharge gate open/close mechanism 31 is opened. Further, the discharge gate open/close mechanism 31 includes a support portion 37, which is supported by the hooking arms 19 on the end portions on the outward side of each gate 33.

### <Main Carriage>

As illustrated in FIG. 2, the main carriage 13 travels back and forth along the rail 11 provided along the coke oven 9. The main carriage 13 stops at a predetermined position at a discharge outlet of the coke oven 9 from which red hot coke is discharged.

### <Rotary Table>

As illustrated in FIG. 2, the rotary table 15 is arranged on the main carriage 13. The rotary table 15 has a function for rotating the conveying bucket 3 placed on the rotary table 15.

Rotating the conveying bucket 3 not only allows the red hot coke to be received in a uniform manner in the conveying bucket 3, but also enables the volumetric efficiency to be improved.

### <Sub-Carriage>

As illustrated in FIGS. 1, 4, and 5, the sub-carriage 17 has the conveying bucket 3 placed thereon, and moves back and forth between the rotary table 15 on the main carriage 13 and the CDQ hoisting tower. More specifically, as illustrated in FIG. 2, the sub-carriage 17, which is self-propelling, travels along a traverse rail 39 provided so as to intersect the rail 11 that is provided along the coke oven 9, and moves back and forth between the CDQ hoisting tower and the main carriage 13.

The sub-carriage is one mode of a conveying bucket moving apparatus according to the present invention.

### [Hoisting Tower]

As illustrated in FIGS. 1 and 6, the hoisting tower 7 includes the hoisting hook 21, the guide rail 23, and the hoisting mechanism 25 which hoists the hoisting hook 21.

### <Hoisting Hook>

As illustrated in FIG. 1, the hoisting hook 21 has a roughly portal shape, and includes hoisting columns 41, a hoisting beam 43 that connects the upper end sides of the hoisting columns 41, and hooking arms 19 that protrude towards the inner side which are provided on a lower end portion of the hoisting columns 41. The hooking arms 19 are configured so that they can support the support portion 37 of the discharge gate open/close mechanism 31 in the conveying bucket 3 placed on the sub-carriage 17 which has arrived at the hoisting tower 7 side.

A first side roller 45 protruding outward is provided on each side of the hoisting hook 21 in the center on the outer face side. A second roller 47 is provided on either side of the first side roller 45. The first side roller 45 is inserted into and rolls along a guide groove 55 of the below-described guide rail 23. The second side rollers 47 abut and roll along an inner face of the guide rail 23. Due to the first side roller 45 and second side rollers 47, the hoisting hook 21 can be raised up and down while stably maintaining its bearing.

The hoisting hook 21 is provided with a bucket cover 49. The bucket cover 49 has a lid 50, and a support member 51 for holding the lid 50. The lid 50 can be arranged so that it encloses the upper portion of the conveying bucket 3.

Slide guides 53 that can move up and down along the hoisting column of the portal-shaped hoisting hook 21 are provided on the support member 51.

### <Guide Rail>

The guide rail 23 includes two vertically continuous bars. In between the two bars, the guide groove 55 is formed.

The support member 51 of the bucket cover 49 is seated on the guide rail 23. Further, the guide rail 23 is provided with a landing seat 56 for positioning the bucket cover 49.

In the conventional example, the guide structure is divided into two, the guide rail 133 and the carriage-side guide rail 117. However, the guide rail 23 according to the present embodiment is a continuous structure that is not separated midway along. Consequently, an operation for aligning the position of the guide rail 133 and the carriage-side guide rail 117, which is required in the case of the conventional example, is not required.

### <Hoisting Mechanism>

The hoisting mechanism 25 includes a moving pulley 57 provided on the hoisting beam 43 on the upper portion of the hoisting hook 21. The hoisting hook 21 can be hoisted to the CDQ facility side by hoisting a wire 59 wound around the moving pulley 57 by a not-illustrated hoisting mechanism.

The operation of the thus-configured present embodiment will now be described.

In FIG. 2, which is an explanatory diagram of the operation carried out when receiving red hot coke, FIG. 2(a) illustrates a state in which the main carriage 13 is located at a position for receiving red hot coke from the coke oven 9; FIG. 2(b) illustrates a state in which the main carriage 13, which received the red hot coke, has moved in an upwards direction in the drawing, and is stopped at the position where the traverse rail 39 is located; and FIG. 2(c) illustrates a state in which the sub-carriage 17 has moved to the hoisting tower 7.

The red hot coke receiving apparatus 5 places the sub-carriage 17 on the rotary table 15 of the main carriage 13, and in a state in which the conveying bucket 3 is placed on the sub-carriage 17, travels along the rail 11 and receives red hot coke from the coke oven 9 at a predetermined position (refer to FIG. 2(a)).

When reception of the red hot coke is finished, the main carriage 13 travels along the rail 11, and moves to the position where the traverse rail 39 is provided (refer to FIGS. 2(a) and 3).

Next, the sub-carriage 17 leaves the rotary table 15, and moves to the hoisting tower 7 (refer to FIGS. 2(c) and 3).

The state of the hoisting tower 7 immediately before the sub-carriage 17 arrives is, as illustrated in FIG. 6, a state in which the hoisting hook 21 has moved downwards. When the hoisting tower 7 is in this state, if the sub-carriage 17 on which the conveying bucket 3 is placed enters the hoisting tower 7, as illustrated in FIG. 7, the hooking arms 19 of the hoisting hook 21 are arranged beneath the discharge gate open/close mechanism 31.

From the state illustrated in FIG. 7, the bucket cover 49 slides down the slide guide 53, and is mounted on an aperture portion of the conveying bucket 3. The mounting of the bucket cover 49 steadies the upper end of the conveying bucket 3, thereby making the conveying bucket 3 stable.

In this state, if the wire 59 is hoisted by driving the hoist apparatus, the hoisting hook 21 moves upwards, so that the hooking arms 19 abut the discharge gate open/close mechanism 31 and support the abutted portions. Consequently, as illustrated in FIG. 8, the conveying bucket 3 is hoisted. When the hoisting hook is moving upwards, the hoisting hook moves smoothly due to the first side roller 45 rolling along the guide groove 55 and the second side rollers 47 rolling along an inner face of the guide rail 23.

As illustrated in FIG. 8, during hoisting of the conveying bucket 3, the lid 50 is held so as to enclose the upper portion of the conveying bucket 3. Consequently, even if a lateral load caused by an earthquake or the like is applied on the conveying bucket 3, there is no danger of the conveying bucket 3 tipping over or the like, since the force is transmitted to the lid 50, slide guides 53, hoisting hook 21, side rollers 45 and 47, and guide rail 23, so that the conveying bucket 3 is supported.

Thus, the present embodiment is configured so that the hoisting hook and other such devices that are not required when receiving red hot coke but are required during hoisting, are arranged on the hoisting tower 7 side. Consequently, accompanying devices that are not necessary when receiving red hot coke are not provided around the conveying bucket, which allows the volume of the conveying bucket itself to be increased.

Further, since the devices necessary for the hoisting of the conveying bucket are concentrated on the hoisting tower 7 side, there is no need to separate the guide rails as in the conventional example. Further, a hoisting hook set 137 having a complex configuration is not necessary. Therefore, the apparatus becomes very simple.

In the above-described embodiment, as a mode for the conveying bucket moving apparatus, an example was described in which a sub-carriage 17 was provided separately to the conveying bucket 3. However, the conveying bucket moving apparatus is not limited to this. For example, further examples of the conveying bucket moving apparatus include, as illustrated in FIGS. 9 and 10, providing an axle 61 on the discharge gate open/close mechanism 31 and providing a wheel 63 on the axle 61. The reason why such configurations are possible is that the discharge gate open/close mechanism 31 has a strength sufficient to support the whole load of the conveying bucket 3 when supported by the hooking arms 19.

Further, in the present embodiment, although an example was described in which there is no rotary mechanism on the sub-carriage 17, and in which the rotary table 15 is provided as the rotary mechanism on the main carriage 13, a rotary mechanism may be provided on the sub-carriage 17 side.

In addition, concerning the hooking arms 17 arranged on a lower portion of the hoisting hook 121, these hooking arms may be a fixed type as described in the above-described embodiment, or may be a structure which includes a function that enables the arms to slide or swing in conjunction with the opening and closing of the discharge gates 33.

1. (canceled)

2. (canceled)

3. (canceled)

4. (canceled)

5. (canceled)

6. A red hot coke receiving and conveying apparatus, comprising a red hot coke receiving apparatus on which is placed a conveying bucket having a discharge gate open/close mechanism on a lower portion, wherein the red hot coke receiving apparatus receives red hot coke from a coke oven by the conveying bucket, and a hoisting tower which hoists the conveying bucket to a coke dry quenching facility side, characterized in that
the red hot coke receiving apparatus comprises a main carriage which travels along a rail provided along the coke oven, a conveying bucket moving apparatus which moves the conveying bucket between the main carriage and the hoisting tower, and a rotary mechanism which is provided on the conveying bucket moving apparatus or the main carriage for rotating the conveying bucket, and
the hoisting tower comprises a hoisting hook having hooking arms capable of holding a lower portion of the
conveying bucket that has moved to the hoisting tower side and a hoisting mechanism for hoisting the hoisting hook.

7. The red hot coke receiving and conveying apparatus according to claim 6, characterized in that the conveying bucket comprises a cylindrical bucket main portion and a lower conical portion having a decreasing diameter, and that the conveying bucket does not have on an upper end portion a flange portion having an increasing diameter.

8. The red hot coke receiving and conveying apparatus according to claim 6, characterized in that the hoisting hook is formed in a portal shape and has a hooking arm on a lower portion of a hoisting column.

9. The red hot coke receiving and conveying apparatus according to claim 7, characterized in that the hoisting hook is formed in a portal shape and has a hooking arm on a lower portion of a hoisting column.

10. The red hot coke receiving and conveying apparatus according to claim 6, characterized in that a bucket cover which covers an upper end aperture portion of the conveying bucket is provided on the hoisting hook, wherein the conveying bucket can be prevented from tipping over by the bucket cover.

11. The red hot coke receiving and conveying apparatus according to claim 7, characterized in that a bucket cover which covers an upper end aperture portion of the conveying bucket is provided on the hoisting hook, wherein the conveying bucket can be prevented from tipping over by the bucket cover.

12. The red hot coke receiving and conveying apparatus according to claim 8, characterized in that a bucket cover which covers an upper end aperture portion of the conveying bucket is provided on the hoisting hook, wherein the conveying bucket can be prevented from tipping over by the bucket cover.

13. The red hot coke receiving and conveying apparatus according to claim 9, characterized in that a bucket cover which covers an upper end aperture portion of the conveying bucket is provided on the hoisting hook, wherein the conveying bucket can be prevented from tipping over by the bucket cover.

14. The red hot coke receiving and conveying apparatus according to claim 6, characterized in that the hoisting tower comprises a guide rail for letting the hoisting hook move up and down, wherein the guide rail is continuous from a minor carriage position.

15. The red hot coke receiving and conveying apparatus according to claim 7, characterized in that the hoisting tower comprises a guide rail for letting the hoisting hook move up and down, wherein the guide rail is continuous from a minor carriage position.

16. The red hot coke receiving and conveying apparatus according to claim 8, characterized in that the hoisting tower comprises a guide rail for letting the hoisting hook move up and down, wherein the guide rail is continuous from a minor carriage position.

17. The red hot coke receiving and conveying apparatus according to claim 9, characterized in that the hoisting tower comprises a guide rail for letting the hoisting hook move up and down, wherein the guide rail is continuous from a minor carriage position.

18. The red hot coke receiving and conveying apparatus according to claim 10, characterized in that the hoisting tower comprises a guide rail for letting the hoisting hook move up and down, wherein the guide rail is continuous from a minor carriage position.

19. The red hot coke receiving and conveying apparatus according to claim 11, characterized in that the hoisting tower comprises a guide rail for letting the hoisting hook move up and down, wherein the guide rail is continuous from a minor carriage position.

20. The red hot coke receiving and conveying apparatus according to claim 12, characterized in that the hoisting tower comprises a guide rail for letting the hoisting hook move up and down, wherein the guide rail is continuous from a minor carriage position.
